(19) United States
(12) Patent Application Publication
(10) Pub. No.: US 2003/0129967 A1
(43) Pub. Date: Jul. 10, 2003

(54) Telecommunication method

(76) Inventor: Steven N. Verona, Columbus, OH (US)

Correspondence Address: Jason H. Foster, Kremblas, Foster, Phillips & Pollick, 7632 Slate Ridge Blvd., Reynoldsburg, OH, 43068, US

(21) Appl. No.: 10/037,985

(22) Filed: Jan. 4, 2002

(51) Int. Cl. H04M 11/10

(52) U.S. Cl. 455/412; 455/445

(57) ABSTRACT

A method of sending an email to an email address, or other electronic message to an electronic address, including a caller dialing a telephone number and inputting a communication code, such as a telephone number, to a central computer to which he is connected. The central computer identifies the intended recipient of the message, either by the telephone number dialed by the caller or by the caller inputting an identifier, such as a PIN. The email message is emailed to the intended recipient's electronic address, which can be a wireless telephone, a PC, a PDA or other device.

### BACKGROUND OF THE INVENTION

1. Field of the Invention

This invention relates generally to a method of communicating with another person, and more particularly relates to a method of using the conventional public telephone system to enter and send an electronic message containing a telephone number or other information to an electronic address, such as an email address, over the Internet.

2. Description of the Related Art

It is known conventionally to use a pager system to receive telephone numbers from those who wish for the pager holder to call back. In a typical system, a caller dials the pager holder's “pager number”, which is a telephone number distributed by the pager holder. The pager number, once dialed, connects the caller with a device or person who prompts the user to enter a telephone number using the telephone keypad. That number is sent by satellite and/or broadcast radio signal to the pager, which receives the number and signals the pager holder either audibly or by vibrating.

The disadvantage of a pager system is that pagers do not effectively transmit information to and from the pager, and therefore if the pager holder wishes to telephone the caller back, he must enter the callback number into a telephone, such as a wireless telephone, and speak to the caller over the conventional telephone system. Such a system necessitates the carrying of two devices: a phone and a pager.

It is also known that wireless telephones and other devices, such as personal digital assistants (PDA) can receive email from the Internet over wireless networks. Such email systems are well known, and the details of the same need not be discussed here. However, the disadvantage of conventional methods of emailing these devices is that the sender must be connected to the Internet to do so. The need exists for a device or method that sends an electronic message, such as an email, to any electronic address, such as an email address from a system that is more readily available than the Internet.

### BRIEF SUMMARY OF THE INVENTION

The invention is a communication method in which a caller uses a telephone system to transmit a communication code to an intended recipient. The method comprises a step of the caller calling a central computer via the telephone system. The telephone system includes both landline and wireless electronic systems working on conventional telephonic principles. The caller inputs at least one intended recipient identifier to the central computer via the telephone system for identifying the intended recipient. The intended recipient identifier can, in a preferred embodiment, be the particular telephone number the caller dialed to connect to the central computer. Alternatively, the identifier can be a personal identification number (PIN) that is input by the telephone keypad, voice or another input device.

Upon receiving the intended recipient identifier, the central computer compares the intended recipient identifier with a plurality of data in a data base corresponding to a plurality of subscribers. The central computer finds a match between the intended recipient identifier and the identifier of at least one of the subscribers in the data base.

The central computer constructs an electronic message addressed to at least one electronic address of the intended recipient. The electronic message can be an email, an “instant message” or any other form sent over the Internet using conventional protocol. The caller inputs, using the telephone keypad, voice or another input device, a communication code, which can be a telephone number, to the central computer via the telephone system. The electronic message contains the telephone number of the caller, or some other information corresponding to the communication code. The central computer transmits the electronic message to the electronic address of the intended recipient, who can receive the same on his wireless phone, computer, PDA or any other device connectable to the Internet.

### BRIEF DESCRIPTION OF THE SEVERAL VIEWS OF THE DRAWINGS

FIG. 1 is a schematic illustration showing the steps of a preferred embodiment of the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### DETAILED DESCRIPTION OF THE INVENTION

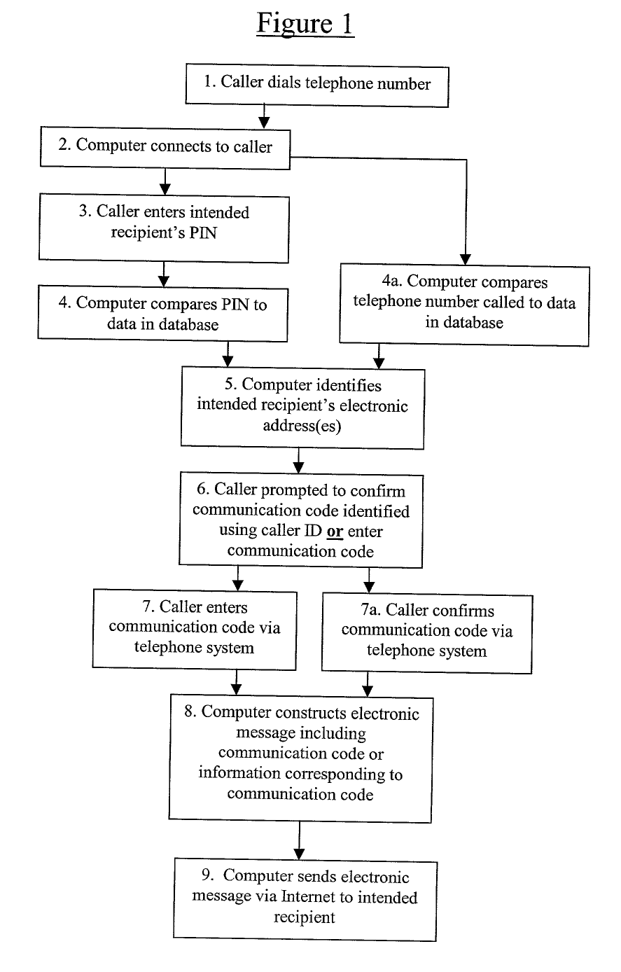

The preferred embodiment of the invention is illustrated in FIG. 1, but before the steps shown are taken, some preliminary steps are preferably taken. First, a person, who is referred to as the intended recipient (of an electronic message), signs up for a subscription with a service provider that will provide the service of transmitting messages to him or her. The intended recipient receives from the service provider a telephone number or numbers, and possibly a personal identification number (PIN) unique to him. The intended recipient then, either in his subscription documents, or by mail, telephone, fax, the Internet or some other means, notifies the service provider of at least one, and possibly many, electronic addresses to which his electronic messages will be sent. The electronic address can be an email address, instant message address or any other electronic address, and can be for his home computer, work computer, PDA, wireless phone, web mail or any other device. It is to be understood that the term “wireless” refers generally to any wireless communication system, whether cellular, satellite or other system. (Most currently produced wireless telephones have an Internet email address.) In a preferred embodiment, the intended recipient can create and amend the list of electronic addresses by connecting to the service provider's web site and entering a password, by telephoning the service provider or by emailing the service provider.

Once the intended recipient has notified the service provider of one or more electronic addresses, he or she then begins to distribute to others the telephone number, and possibly a PIN, assigned to him or her. Those others are informed that if they want to communicate a message to the intended recipient, they may do so by calling the telephone number.

Thus, a first step of the preferred method illustrated in FIG. 1 is the step of a caller dialing the telephone number using the telephone system. It is to be noted that the order of the steps illustrated and described herein is not critical, and a person having ordinary skill in the art will understand that the order can be changed from what is shown without materially altering the essence of the invention. The telephone number dialed is the telephone number that the intended recipient distributed to others for contacting him. The caller dials the telephone number, such as on a landline, cellular, satellite or other telephone, and is connected over conventional telephonic equipment to the central computer of the service provider to which the intended recipient subscribes.

When the caller dials the telephone number and connects to the computer, the identity of the intended recipient of the electronic message must at some time be communicated to the computer in order for the computer to address an electronic message to the intended recipient. There are at least two ways in which the intended recipient of the electronic message can be identified. In the first way, the telephone number dialed by the caller is a unique telephone number devoted exclusively to the intended recipient, and therefore the dialing of the number by the caller inputs automatically to the computer a unique intended recipient identifier: the telephone number. When that number is dialed by the caller and the central computer connects to the caller, the computer compares the telephone number the caller dialed with data in a database for all subscribers to its service, one record of which is for the intended recipient. The computer identifies the intended recipient by this telephone number, and associates with the intended recipient the one or more electronic addresses the intended recipient gave to the service provider. For example, there could be two electronic addresses, such as the email address of the intended recipient's wireless telephone, and the email address of the intended recipient's home personal computer (PC).

Alternatively, if it is not desirable for the service provider to give a unique telephone number to each subscriber, a plurality of subscribers can be given the same telephone number in addition to a unique identifier, such as a PIN. Thus, upon calling the multi-user telephone number, connecting to the central computer and being prompted, such as by a tone or automated menu, the caller inputs the PIN or other unique identifier to the computer to identify the intended recipient. This is accomplished in a simple embodiment by using the telephone keypad to enter a single or multi-digit PIN, and in a more complex embodiment by the caller speaking into the telephone, or using special hardware or some other input means to communicate a unique intended recipient identifier to the computer. One means for inputting this information, or any information, to the computer, is a sound-generating device that is programmed to produce one or more series of DTMF or other tones. These series of tones are pre-programmed into the device and can be projected into the mouthpiece of the telephone by pressing one or more buttons on the same. After the unique identifier is input by the caller, the computer compares the unique identifier to the data in its database and identifies the intended recipient and his or her electronic address or addresses.

Either before or after the intended recipient, and the electronic addresses associated with him, are identified, the computer prompts the caller to input a communication code to it. The communication code will typically be the telephone number at which the caller wishes the intended recipient to call him back, but also could be an electronic address, such as an email address, or other information. In a particular example, the communication code can be one of a plurality of pre-programmed codes that the central computer recognizes as corresponding to a pre-programmed message or other information. In this example, the intended recipient can program the central computer to associate the communication code that is input to the central computer as the spoken words “call me at home” with the home telephone number of the caller. Alternatively, the intended recipient can program the central computer to associate the touch tone sequence “234”, which is input to the computer by pressing keys on a telephone keypad, with an alphanumeric message, such as the message “call your husband at home.” The information corresponding to the communication code is then placed, by the central computer, in the electronic message that is sent to the intended recipient. Thus, “information corresponding to the communication code” is defined as the communication code itself (e.g., a telephone number) or alphanumeric characters or audible or visual information generated in response to the communication code. The programming of the central computer to associate codes and alphanumeric characters can take place over the Internet just as the intended recipient communicated the electronic addresses to the central computer.

Thus, one option for a communication code is for the caller to input a telephone number or other code manually, such as by the telephone keypad, verbally or using another input device, such as a pointing device, touch screen, sound-generating device, etc. Thus, the caller dials, speaks or otherwise inputs his communication code into the telephone using the telephone keypad (which produces DTMF tones recognized and distinguished by the computer), his voice, etc.

As an alternative, the caller's call can supply, using conventional “caller ID” technology, the computer with the caller's telephone number as described above. Thus, the computer can prompt the caller to confirm that the telephone number (which is the possible communication code, because the caller has not yet confirmed it) is in fact the caller's communication code. This can be confirmed using any input device, including the telephone keypad, caller voice response or a sound-generating device.

The step in the preferred method that follows the caller either entering a communication code or confirming a possible communication code, is for the computer to construct an electronic message to the address or addresses associated with the intended recipient. The message is constructed to contain the communication code (or the information corresponding to the communication code, such as a text message, a telephone number, etc.). In a preferred embodiment the electronic message also includes the time and date of the call. The electronic message is then sent via the Internet to the intended recipient's electronic address or addresses. The intended recipient can receive the electronic message at any device capable of receiving electronic messages, whereupon he can read the same and decide when and how to respond.

If the electronic message is received, for example, on the intended recipient's wireless telephone, which is accomplished using conventional technology that wireless telephone service providers currently use to send Internet emails to wireless telephones, the intended recipient may not need to re-enter the telephone number of the caller if the electronic message contains the caller's telephone number. This is because the telephone number is already in the body or subject line, for example, of the email message, and the telephone can be commanded to call back automatically the number by one keystroke or verbal instructions on a voice-activated telephone. This avoids mistakes that can arise when using a pager to receive callback numbers and then re-entering the number into a wireless or other telephone.

The term “electronic message” is, in the preferred embodiment, an email sent over the Internet using conventional Internet protocol. Thus, the invention is compatible with any Internet email-receiving device. Alternatively, the electronic message can be what is conventionally known as an “instant message.” Of course, other kinds of electronic messages may exist or come into existence that do not fall into the categories of email or instant messages. Such electronic messages fall within the scope of the instant invention if they are sent over the Internet using then-existing Internet protocol.

An additional advantage of the instant invention is that every electronic message sent to the intended recipient can be sent to more than one electronic address, which permits the intended recipient to keep records of the calls received on a particular computer or device separate from the wireless phone. This permits easier timekeeping, retaining of client phone numbers, etc.

Other options are available for the computer answering the caller's call. For example, an automated system allows the caller to enter a special PIN (either in addition to or as a substitute for a unique identifier PIN) that sends the caller's call through to the intended recipient's wireless phone, rather than, or in addition to, the caller inputting a communication code. Furthermore, voice mail, fax and other services can be combined with the instant invention by conventional menu systems. Such services can be operated conventionally, or the central computer can email faxes and voice mail messages in data and sound files, respectively, to electronic addresses indicated by the subscriber as capable of receiving them.

Another option exists for businesses or families that want to send emails to a plurality of people. The intended recipient can program email addresses into the service provider's central computer, such as by using a browser over the Internet, that are grouped according to preferences and then a menu item for each group is created. Then, when a caller calls, he can use a menu option to send an electronic message to a selected group, for example, every salesperson in the company. The salespeople each receive an email or instant message containing the callback number or other information corresponding to the communication code, and each responds accordingly. A family can use the option to set up groups for siblings, parents, grandchildren, etc.

The central computer is, by way of example only, a conventional server running the UNIX operating system and connected continuously to the telephone system and the Internet by a T1 or other similar connection. Database software contains the data related to each subscriber, in separate records. The computer is preferably connected to the Internet in a manner that permits subscribers to, using passwords or other security mechanism, enter and modify their lists of electronic addresses to which electronic messages are sent by the computer. Of course, the central computer could be a plurality of computers, computer programs and other devices connected locally or over a large geographic area to provide the same function as the exemplary central computer.

A hybrid of the alternatives discussed above of (a) each subscriber having his own telephone number and (b) multiple subscribers having the same telephone number but a unique PIN is the following. A unique number is assigned to each subscriber, and the subscriber may choose to have separate PINs for each email address, or for groups of email addresses. Thus, the subscriber can give out one PIN to some people, for example family, and another PIN to other people, for example business associates.

While certain preferred embodiments of the present invention have been disclosed in detail, it is to be understood that various modifications may be adopted without departing from the spirit of the invention or scope of the following claims.

1. A communication method in which a caller uses a telephone system and the Internet to transmit an electronic message to at least one electronic address of an intended recipient, the method comprising:
(a) said caller dialing a telephone number via the telephone system for connecting to a central computer;
(b) said central computer comparing an intended recipient identifier with data corresponding to a plurality of subscribers;
(c) said caller inputting a communication code into the central computer via the telephone system;
(d) said central computer constructing an electronic message addressed to at least one electronic address of the intended recipient, said electronic message containing information corresponding to the communication code; and
(e) said central computer transmitting the electronic message over the Internet to said at least one electronic address of the intended recipient.

2. The method in accordance with claim 1, further comprising the step of said caller inputting said intended recipient identifier into the central computer via the telephone system.

3. The method in accordance with claim 2, wherein the information corresponding to the communication code further comprises a telephone number of the caller.

4. The method in accordance with claim 2, wherein the information corresponding to the communication code further comprises a plurality of alphanumeric characters.

5. The method in accordance with claim 2, wherein the step of inputting said intended recipient identifier further comprises manually contacting at least one button on a telephone.

6. The method in accordance with claim 2, wherein the step of inputting said intended recipient identifier further comprises projecting sound waves into a telephone.

7. The method in accordance with claim 6, wherein the step of projecting sound waves further comprises speaking.

8. The method in accordance with claim 1, wherein said intended recipient identifier is transmitted to said central computer when the caller dials said telephone number.

9. The method in accordance with claim 8, wherein the information corresponding to the communication code further comprises a telephone number of the caller.

10. The method in accordance with claim 8, wherein the information corresponding to the communication code further comprises a plurality of alphanumeric characters.

11. The method in accordance with claim 8, wherein the step of inputting a communication code further comprises confirming a possible communication code.

12. The method in accordance with claim 11, further comprising the step of the central computer prompting the caller to contact manually at least one telephone button to confirm that the possible communication code audibly communicated to the caller is the communication code.

13. The method in accordance with claim 11, further comprising the step of the central computer prompting the caller to speak to confirm that the possible communication code audibly communicated to the caller is the communication code.

14. The method in accordance with claim 1, wherein the step of inputting a communication code further comprises manually contacting at least one button on a telephone.

15. The method in accordance with claim 14, further comprising manually contacting a plurality of buttons in sequence on the telephone after prompting by the central computer.

16. The method in accordance with claim 1, wherein the step of inputting a communication code further comprises projecting sound waves into a telephone.

17. The method in accordance with claim 16, wherein the step of projecting sound waves further comprises speaking.

18. The method in accordance with claim 1, wherein the electronic message uses Internet protocol.

19. The method in accordance with claim 18, wherein the electronic message is an instant message.

20. The method in accordance with claim 18, wherein the electronic message is an email message.

21. The method in accordance with claim 20, wherein the electronic address is a webmail email address.

22. The method in accordance with claim 20, wherein the electronic address is a PDA email address.

23. The method in accordance with claim 20, wherein the electronic address is a personal computer email address.

24. The method in accordance with claim 20, wherein the electronic address is a wireless telephone email address.

25. The method in accordance with claim 24, further comprising the step of calling back a telephone number that is contained in the electronic message on the wireless telephone.

26. The method in accordance with claim 1, further comprising the step of connecting to the central computer over the Internet and modifying said at least one electronic address.

27. The method in accordance with claim 1, further comprising:
(a) said caller leaving a recorded voice message; and
(b) said central computer sending a computer file containing the recorded voice message to said at least one electronic address.

28. The method in accordance with claim 1, further comprising:
(a) said caller leaving a recorded voice message; and
(b) said central computer sending an electronic message to said at least one electronic address notifying said intended recipient of said recorded voice message.

29. The method in accordance with claim 1, further comprising said central computer connecting said caller with said intended recipient over the telephone system.
